(19) United States
(12) Patent Application Publication
(10) Pub. No.: US 2003/0146031 A1
(43) Pub. Date: Aug. 7, 2003

(54) Method of obtaining annotated electronic tracks on road

(76) Inventor: Hoton How, Belmont, MA (US)

Correspondence Address: Hoton How, 262 Clifton Street, Belmont, MA, 02478, US

(21) Appl. No.: 10/060,775

(22) Filed: Feb. 1, 2002

(51) Int. Cl. B62D 1/24

(52) U.S. Cl. 180/167; 340/933; 701/23

(57) ABSTRACT

Disclosed is a method for establishing and utilizing annotated electronic tracks on road for ground vehicles so as to ease the driving task with added safety, efficiency, and economy. Electronic tracks define traces on roads guiding the movement of a ground vehicle in as much as the same way that railroad tracks confine the movement of a train. Road track marks are detected using electronic transducers which generate control signals on the wheels to maintain the trajectory of a ground vehicle confined to a predetermined trace on road. A ground-vehicle train can thus be set up on road, requiring one driver to navigate or manipulate the movement of the whole train consisting of many ground vehicles. Annotations are also provided by electronic tracks on road. When combined with other technologies, such as electronic maps, internet connections, and collision avoidance radars, the driving of a ground vehicle on road suppling annotated electronic tracks can be fully computerized thereby achieving automation.

### CROSS-REFERENCE TO RELATED APPLICATIONS

Title of Invention: Electronically Tracked Road-Map System

Filing Date: May 7, 2001

Name of Applicant: Hoton How

application Ser. No. 09/849,894

### BACKGROUND—FIELD OF INVENTION

This invention is directed to a method of establishing and utilizing electronic tracks on road which can be subsequently used to assist and aid the driving of a ground vehicle. In other words, electronic tracks are set up on road providing guidance of a ground vehicle on sailing, thereby easing the task of the driver and adding safety and comfort to the passengers.

### BACKGROUND—DESCRIPTION OF PRIOR ART

Railroad tracks are set up permanently on routes connecting spots of interesting admitting scheduled commuting of cargos and passengers. A train sails or glides along a railroad track, because the wheels are confined only to the track of a railroad, and nowhere else. This makes driving a train a very much easy task. What the driver needs to do is to watch the speed regulation signs on gliding, accelerating or slowing down the train if necessary. In principle, the driver has no concern at all on controlling the direction of the train, because the route of its journey, or the track of the railroad, has already be fixed before sailing. Most importantly, one operator is sufficient in manipulating the movement of a train, because all of the train compartments are tied together to be placed on top of a common track of the railroad.

It is a different story on driving a ground vehicle on road. In contrast, the driver has to pay full attention to control the direction of the vehicle, in addition to efforts in making speed adjustments, because there is no track on road for the vehicle. Thus, driving a ground vehicle on road is a painful task, and the driver has to be alerted against direction changes all the time during driving. This translates into high risks and high expenses. When many ground vehicles teamed up sailing along a common route, each vehicle requires one driver to operate, despite of the fact that all of the drivers are repeating one another's action. Automation in driving a ground vehicle is almost impossible.

Furthermore, the regulation rules imposed upon a road can not be acquired at ease. The driver has to, in addition to pay full attention on controlling the direction of the vehicle, browse carefully signs installed at the road sides along with the driving action, so as not to miss a single message to violate the law and to develop an accidence. These signs include restriction on, for example, speed limit, school zone, traffic lights, etc.. This can distract a lot the driver's driving efforts. Other information, such as milestones, street orientation, dynamic data of the present road on driving, are even harder to obtain. The driver has to watch carefully the name of a street on passing before he or she could possibly miss an exit.

Accordingly, it is an objection of the invention to address one or more of the foregoing disadvantages or drawbacks of the prior art, and to provide such an improved method to obtain annotated electronic tracks on roads for ground vehicles for aiding and assisting road riding. This can not only ease the task of driving a ground vehicle, but also add safety and comfort to road transportation. By combining other technologies with annotated electronic road tracks, such as electronic maps, internet connections, collision avoidance radars, it is even possible to achieve automation along with road driving. It is also feasible to set up ground-vehicle trains on road.

Other objects will be apparent to one of ordinary skill, in light of the following disclosure, including the claims.

### SUMMARY

In one aspect, the invention provides a method which sets up electronic tracks on road confining and guiding the movement of a ground vehicle. The tracks are established on road with marks or symbols which can be read or visualized via the use of an electronic transducer. Once launched on an electronic track, a ground vehicle can then control its sailing direction by itself, thereby adding safety and efficiency to the ground vehicle.

In another aspect, the invention discloses a method which allow the electronic tracks on road to be annotated, providing the driver with regulation rules imposed on the road and information about the environment of the road. When combined with an electronic map linking together all of the roads, the driving action can even be computerized, giving rise to programmed driving at automation.

### BRIEF DESCRIPTION OF THE DRAWINGS

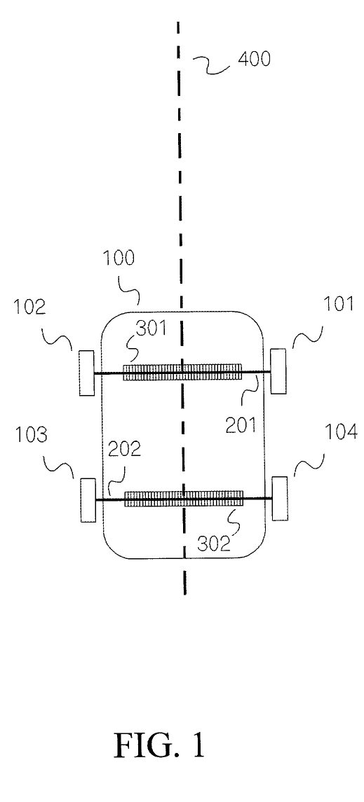

For a more complete understanding of the nature and objectives of the present invention, reference is to be made to the following detailed description and accompanying drawing, which, though not to scale, illustrate the principles of the invention, and in which FIG. 1 shows one example of the preferred embodiment of the invention that a ground vehicle is riding on an electronic track providing direction guidance and static/dynamic information to the ground vehicle sailing on road.

### DETAILED DESCRIPTION

REFERENCE NUMERALS IN DRAWINGS

| | |
|---|---|
| 100 | Ground Vehicle |
| 101, 102, 103, 104 | Wheel |
| 201, 202 | Wheel Axle or Shaft |
| 301, 302 | Electronic Transducer |
| 400 | Electronic Track on Road |

### DETAILED DESCRIPTION

### GENERAL DISCUSSIONS

A train can move only on the track of a railroad, or the movement of a train is confined and guided by the track of a railroad. To drive a train one needs, in principle, only to control the speed of the train, but not its direction, making stops and then re-starts at various train stations. If tracks can be set up on roads, not physically but electronically, a ground vehicle can then travel by itself on tracks, thereby easing the task of driving the vehicle. In the following an electronic track is first described, followed by subsequent use of the track by a ground vehicle.

Instead of laying steel tracks on road to confine the movement of the wheels of a ground vehicle, as dictated by a railway track applied to a train, marks or symbols are deposited on road which can be consequently read or visualized by the vehicle via the use of electronic transducers. Once detected these marks, information obtained are analyzed by a computer installed with the ground vehicle so as to enforce the wheels of the vehicle to follow the marks to trace out a predetermined trajectory on road. In this sense an electronic track on road resembles exactly a steel track designed for a train by which the movement of a ground vehicle is thereof confined and regulated. Once launched on an electronic track, the vehicle can move nowhere but along the trace of the track, and what the driver needs to do is to watch out if anything protruding before the vehicle so as to make corresponding adjustment in the speed of the vehicle. This eases the task of driving a ground vehicle on road. The added safety, comfort, and economy to the driver, as well as to the passengers and/or cargos, is thus realized.

Marks or symbols can be applied on road in many ways, so long as they can be reliably detected via the use of certain electronic transducers, and their appearance will not interfere with the normal driving functions of ground vehicles on road. For example, poles may be installed at road sides at regular distances so as to mark the trajectory of a trace. For the preferred embodiment of the invention, planar marks paved on or buried under the surface of a road are thought more attractive under both reliability and economy considerations. Traffic marks or lines are commonly painted on the surface of a road to define lanes thereof as well as to declare its regulation. For example, a yellow line on road means no trespassing, and dashed white lines mean passing other vehicles is allowed across these lines, and so on. Analogously, track marks can be placed on or under the surface of a road, so long as they can be detected reliably by electronic transducers, but not by human eyes, as implied by regular traffic lines. Once detected, the position as well as orientation of these track marks translates into electronic signals controlling the direction of the wheels of the ground vehicle to comply fully with the trajectory defined by the track marks.

Depending on the kind of electronic transducers used, track marks can appear in many forms, which are consequently discussed as follows:

### i) Optical Marks

Optical marks resemble very much regular traffic lines painted on road, except that they may be designed to operate at different spectra of the light frequency. For example, infrared laser lights are easy to generate, to propagate, and to detect, and hence they may be favorably used to locate optical marks. Thus, special materials, such as paints which exhibit sufficient contrast on the reflection of infrared lights in comparison to the surface of an asphalt or a cement road, for example, can be paved or painted on road to form track marks.

### ii) Low-Frequency Electrical Marks

Thin metal layers may be deposited on the surface of a road to form the trace of a track. Detection of metal layers can be readily carried out by illuminating the track with low-frequence electrical signals followed by the detection of the eddy currents induced on the metal layers. Equivalently, metal wires can be buried under the surface of a road to define an unseen track, whose presence can also be identified by characterizing the induced eddy currents. Buried marks are insensitive to weather conditions. For example, raining and snowing may affect little the detection of eddy currents on metal wires, as contrasted to optical marks in response to road conditions.

### iii) High-Frequency Electromagnetic Marks

Instead of applying low-frequency electrical signals, high-frequency electromagnetic signals may also be used in the detection of track marks on road. In this case the track marks appear in the form of printed antennas characteristic of a compact geometry resonating at discrete microwave frequencies, for example, a dipole arm, a disk, etc.. Thus, by illuminating these marks at their respective resonant frequencies, their presence can thus be identified. Due to the high discriminating nature in the resonant frequencies, detection of these marks provides a high resolution power, since the signal-to-noise ratio is high. High-frequency electromagnetic marks can also be buried underground to provide weather independent service.

### iv) Magnetic Marks

Magnetic taps or tags may be buried underground to define the trace of a track on road. Two kinds of magnetic taps may be distinguished. A soft tag means it has a vanishing magnetic moment, whereas a hard tag means it has a finite remanence magnetization. Detection of a soft tag needs the tag to be magnetized first, whereas a hard tag can be directly checked out by employing a magnetometer. Background magnetic field, for example, the earth field, can be subtracted out from the measurement via a normalization process. Magnetic marks are also insensitive to road conditions.

### v) Acoustic Marks

Acoustic marks can be fabricated using piezoelectric materials. Acoustic marks are shaped as mechanical resonators, such as tags, disks, etc., showing resonance at ultrasound frequencies. Operation of acoustic marks is similar to high-frequency electromagnetic marks. That is, ultrasound signals are used illuminating at acoustic marks whose frequency coincides with the resonant frequencies of the marks. The reflected beam will show a large cross section in scattering thereby identifying the existence of the marks. Acoustic marks are also insensitive to road conditions.

### vi) Hybrid Marks

A metal strip on road can reflect an illuminated laser beam as well as to induce eddy currents upon low-frequency electrical excitation. Thus a metal strip on road allows both detection schemes to be applied simultaneously. This can increase the sensitivity in the detection of road tracks, and hence reliability for their operation, without increasing much their installation fees. Alternatively, magnetostrictive tags or taps may be used to define a road track so that the interrogation signals and the response signals belong to different categories. That is, the interrogation signals can be low-frequency electrical signals and the response signals are ultrasounds, or vice versa; on detecting the track marks these two kinds of signals present high isolation, resulting in a high resolution power. Other hybrid marks are also possible.

A road track can also be coded with information to provide maximum usage. For example, digital bits can be included with the track marks so that on reading track marks on road, they supply not only the direction or orientation of the track, but also information about the track, including its name, milage, streets on intersection, warning on a slippery road, reminder for signal lights ahead, and traffic regulation rules imposed thereof, etc.. When combined with an electronic map connected to relevant internet sites, one is able to perform computerized driving, relying fully on the computer to select a route on traveling, taking into account weather conditions, traffic conditions, road-construction conditions, etc.. What the driver needs to do is to sit back watching against emergence, if any. Collision avoidance radar may also be used to detect the protrusion of unexpected objects. The speed of a preceding vehicle may also be monitored, modifying the speed of the vehicle according, thereby achieving automation in driving.

A train is divided in multiple sections, called compartments, and only one engin is needed installed with the first section, called locomotive, to drag or pull the other sections. Ground vehicles driving on a common road track can also be correlated in a similar manner. That is, many ground vehicles can be placed on the same road track lining up in sequence. One driver is needed, siting on the first vehicle, in charge of the sailing of the whole sequence of the ground vehicles. A ground-vehicle train is highly plausible at least under highway conditions where traffic lights are absent. It is known that the fees on freight are mostly due to driver costs. If a cargo-train can be set up on road employing only one driver, the cost on transportation can thus be considerably reduced.

### PREFERRED EMBODIMENT:—FIG. 1

FIG. 1 shows an example of the preferred embodiment of the invention that a ground vehicle, 100, is sailing or gliding along an electronic track, 400. The four wheels of the ground vehicle 100 are shown in FIG. 1, denoted as 101, 102, 103, 104. Two electronic transducers, 301 and 302, are installed with the ground vehicle 100, to be located at midpoints of wheel axles, or shafts, 201 and 202, respectively. These two electronic transducers 301 and 302 continuously monitors or detects the track 400 so that the trace of the track 400 always falls at midpoints of the transducers 301 and 302. Any misalignment or misplacement of the track 400 deflected away from the central line of the ground vehicle 100 detected by the transducer 301 and 302 results in a modification signal, forcing the wheels 101, 102, 103, 104 to rotate accordingly, making the ground vehicle 100 to stay all the time on track, in as much as a regular railway track does. Although one electronic transducer suffice for the disclosed operation, two electronic transducers 301 and 302 are shown in this preferred example of embodiment of the invention for the purpose of achieving high reliability in performance.

In FIG. 1 the electronic track 400 is annotated with information so that the electronic track 400 can not only guide the direction of the ground vehicle 100 on sailing, but also provide necessary data about the track 400. In FIG. 1 a digit “1” is represented by a long bar, or a long line-segment, and a digital “0” is by a short bar, or a short line-segment. Other geometries or figures of these digital marks are also possible, for example single lines for digital “0” and double lines for digital “1”. Error detecting codes may be included with the track to ensure accurate data acquisition. The explicit dimension and geometry of the electronic track 400 depends on the type of electronic transducers 301, 302, employed, namely, the responding time of the transducers as well as their sensitivities. For optical marks the track resembles a traffic line painted on the surface of a road, as shown in FIG. 1. Other marks may assume a compact geometry, giving rise to discrete resonant frequencies. Or, they may be buried underground unseen to human eyes, as discussed previously.

I claim:

1. A method of obtaining annotated electronic tracks on road, comprising
A) setting up electronic track marks on said road,
B) installing electronic transducers on a ground vehicle capable of detecting said electronic track marks on said road,
wherein on driving said ground vehicle on said road said electronic transducers continuously detect and monitor said electronic track marks on said road, gaining knowledge necessary to maintain the trajectory of said ground vehicle to follow a predetermined trace on said road, in addition to other information supplied by said electronic track marks, thereby easing the task of driving said ground vehicle with added safety and efficiency.

2. The method of claim 1 wherein said electronic track marks consist of optical marks.

3. The method of claim 1 wherein said electronic track marks consist of low-frequency electrical marks.

4. The method of claim 1 wherein said electronic track marks consist of high-frequency electromagnetic marks.

5. The method of claim 1 wherein said electronic track marks consist of magnetic marks.

6. The method of claim 1 wherein said electronic track marks consist of acoustic marks.

7. The method of claim 1 wherein said electronic track marks consist of hybrid marks.

8. The method of claim 1 wherein said other information supplied by said electronic track marks consist of digital data annotating the conditions and environment of said road in relation to other roads, constructions, buildings, geographical locations, traffic statistics, and so forth.

9. The method of claim 1 wherein said annotated electronic tracks on said road allow other technologies to be applied in combination, including electronic maps, internet connections, collision avoidance radars, so that the driving of said ground vehicle can be fully computerized achieving automation.

10. The method of claim 1 wherein said annotated electronic tracks on said road permit ground-vehicle trains to be formed demanding a minimal number of drivers to navigate or manipulate the sailing of said ground-vehicle trains.
